(19) United States
(12) Patent Application Publication
(10) Pub. No.: US 2023/0168929 A1
(43) Pub. Date: Jun. 1, 2023

(54) RESOURCE OPTIMIZATION FOR RECLAMATION OF RESOURCES

(71) Applicant: Rakuten Mobile, Inc., Tokyo (JP)

(72) Inventors: Amey WADEKAR, Tokyo (JP); Mihir PATHAK, Tokyo (JP)

(21) Appl. No.: 17/457,021

(22) Filed: Nov. 30, 2021

(51) Int. Cl. G06F 9/50

(52) U.S. Cl. CPC G06F 9/5005; G06F 2209/508; G06F 2209/5011; G06F 2209/5014

(57) ABSTRACT

A method includes receiving a reservation request corresponding to resource requirements of an application. The reservation request including an amount of resources requested for the application. Determining an initial intra-tenant threshold based on the reservation request. Reserving an amount of intra-tenant resources. The amount of intra-tenant resources reserved being greater than the amount of resources requested. Monitoring tenant resource usage assigned to execute the application. The method further includes storing resource usage data periodically. The method further includes predicting future tenant resource usage based on the resource usage data. The method further includes responsive to the predicted future tenant resource usage, performing at least one of: determining a new intra-tenant threshold to be recommended in response to the initial intra-tenant threshold being set too high or too low, or generating an alert indicating that the initial intra-tenant threshold is insufficient to support the predicted future tenant resource usage.

### BACKGROUND

Telecom (e.g., wireless, cellular, and the like) and other application workloads are increasingly being transitioned to cloud native applications deployed on data centers that include multiple server clusters. The server clusters are capable of having a variety of resources that are often shared among multiple applications.

In software as a service (SaaS) model, users gain access to application software and databases. Cloud providers manage the infrastructure and platforms that run the applications. SaaS is sometimes referred to as on-demand software and is usually priced on a pay-per-use basis or using a subscription fee. In the SaaS model, cloud providers install and operate application software in the cloud and cloud users access the software from cloud clients. Cloud users do not manage the cloud infrastructure and platform where the application runs. This eliminates the need to install and run the application on the cloud user’s own computer, which simplifies maintenance and support. Cloud applications differ from other applications in scalability, which is achieved by cloning tasks onto multiple virtual machines at run-time to meet changing work demand. Load balancers distribute the work over the set of virtual machines. This process is transparent to the cloud user, who sees only a single access-point. To accommodate a large number of cloud users, cloud applications is multitenant, meaning that any machine serves more than one cloud-user organization.

### BRIEF DESCRIPTION OF THE DRAWINGS

Aspects of the present disclosure are best understood from the following detailed description when read with the accompanying figures. In accordance with the standard practice in the industry, various features are not drawn to scale. In fact, the dimensions of the various features is arbitrarily increased or reduced for clarity of discussion.

FIG. 1 is a block diagram of a communication system, in accordance with some embodiments.

FIG. 2 is a block diagram of a system, in accordance with some embodiments.

FIG. 3 is a block diagram of a system, in accordance with some embodiments.

FIG. 4 is a block diagram of a system, in accordance with some embodiments.

FIG. 5 is a flow diagram of a method of operating a system, in accordance with some embodiments.

FIG. 6 is a block diagram of a system, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows includes embodiments in which the first and second features are formed in direct contact, and also includes embodiments in which additional features is formed between the first and second features, such that the first and second features not be in direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as “beneath,” “below,” “lower,” “above,” “upper” and the like, is used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein are likewise interpreted accordingly.

In some embodiments, a system of one or more computers are configured to perform particular operations or actions by virtue of having software, firmware, hardware, or a combination of them installed on the system that in operation causes or cause the system to perform certain actions. In some embodiments, one or more computer programs are configured to perform particular operations or actions by virtue of including instructions that, when executed by a processor, cause the apparatus to perform the actions. In some embodiments, a method executed by the processor includes receiving a reservation request corresponding to resource requirements of an application. In some embodiments, the reservation request includes an amount of resources requested for the application. In some embodiments, the method further includes determining an initial intra-tenant threshold based on the reservation request. In some embodiments, the method further includes reserving an amount of intra-tenant resources. In some embodiments, the amount of intra-tenant resources reserved is greater than the amount of resources requested. In some embodiments, the method further includes monitoring tenant resource usage assigned to execute the application. In some embodiments, the method further includes storing resource usage data periodically. In some embodiments, the method further includes predicting future tenant resource usage based on the resource usage data. In some embodiments, the method further includes, responsive to the predicted future tenant resource usage, performing at least one of (1) determining a new intra-tenant threshold to be recommended in response to the initial intra-tenant threshold being set too high or too low, or (2) generating an alert indicating that the initial intra-tenant threshold is insufficient to support the predicted future tenant resource usage.

A tenant is a user or group of users who share a common access with specific privileges to a software application. With a multitenant architecture, a software application is designed to provide every tenant a dedicated share of the application - including data, configuration, user management, tenant individual functionality and non-functional properties. Multitenancy contrasts with multi-instance architectures, where separate software instances operate on behalf of different tenants. Multitenancy is a feature of cloud computing.

Other approaches do not set an intra-tenant resource limit for a tenant. Further, other approaches do not incorporate artificial intelligence (AI) or machine learning (ML) engines to predict a future trend in resource usage. Other approaches further do not incorporate artificial intelligence (AI) or machine learning (ML) engines to determine a recommendation of intra-tenant limit to optimize the resource utilization. Other approaches further do not incorporate the configuration of a resource limit.

AI is any system that perceives an environment and takes actions that optimize chances of achieving goals. Some use the term artificial intelligence to describe machines that mimic cognitive functions that humans associate with the human mind, such as learning and problem solving. Machine learning techniques, such as deep learning, learn features of data sets, instead of the programmer defining them individually. The algorithm further learns how to combine low-level features into more abstract features, and so on. This multi-layered approach allows such systems to make sophisticated predictions when appropriately trained.

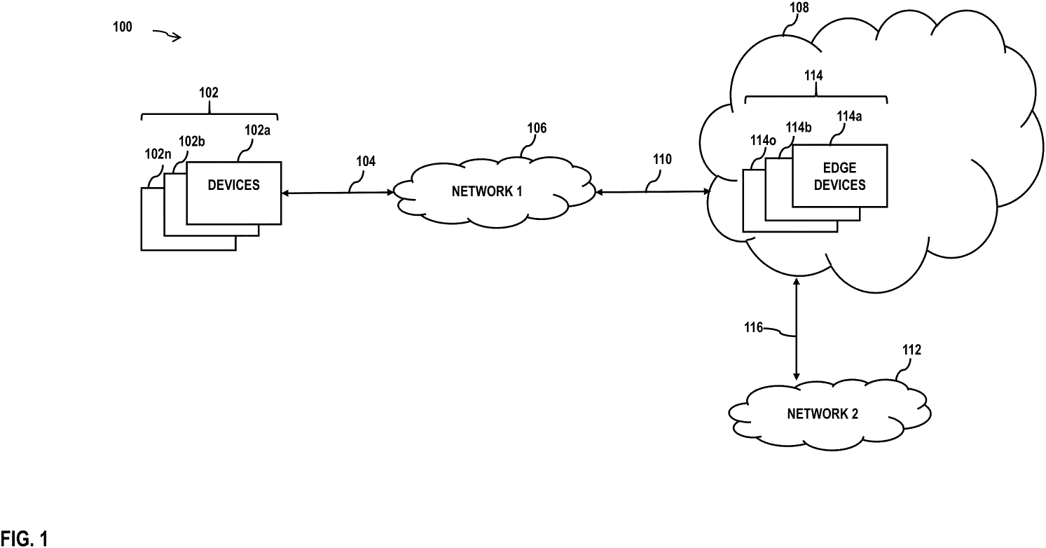

FIG. 1 is a block diagram of a communication system 100 (hereinafter referred to as “system 100”), in accordance with some embodiments.

System 100 includes a set of devices 102 coupled to a multi-tenant cloud system 108 by a link 104, a network 106, and a link 110. System 100 further includes a network 112 coupled to the multi-tenant cloud system 108 by a link 116.

System 100 includes a multi-tenant cloud system 108. In some embodiments, a multi-tenant cloud system 108 is optimized through resource allocation. In some embodiments, a multi-tenant cloud system 108 performs system optimization to prevent waste of resources. In some embodiments, multi-tenant cloud system 108 is optimized so that when a resource request which is less than optimal is provided by a user at one of devices 102, multi-tenant cloud system 108 optimizes the resource allocation over time. In some embodiments, if a user either requests too many resources or too little resources, multi-tenant cloud system 108 is configured to modify the user’s request and removes any barriers for new user usage since the user is not required to have good knowledge or experience to accurately specify the amount of resources for executing a desired application. Rather, the user inputs the information of the application (e.g., with or without an appropriate amount of resources) and multi-tenant cloud system 108 automatically determines and recommends the amount of resources to properly execute the desired application.

In some embodiments, optimizing utilization of resources (e.g., avoid waste of resources, reclaim unused resources allocated to a tenant when a user deploys a new application and does not request the correct amount of resources, and the like). In some embodiments, resource optimization improves the efficiency of multi-tenant cloud system 108. In some embodiments, resource optimization reduces costs for the user/vendor, since the user/vendor is not paying for unused resources. Further, in some embodiments, the performance of the application is optimized (e.g., avoid insufficient resources assigned to the application due to incorrect resource requests by the user).

The set of devices 102 includes devices 102a, 102b, through 102n, where n is a positive integer corresponding to a number of devices in the set of devices 102. In some embodiments, one or more devices in the set of devices 102 corresponds to a computing device, a computing system or a server. In some embodiments, set of devices 102 are machines that are programmed to carry out sequences of arithmetic or logical operations automatically. In some embodiments, set of devices 102 perform generic sets of operations known as programs. These programs enable set of devices 102 to perform a wide range of tasks. In some embodiments, set of devices 102 is a group of computers that are linked and function together, such as a computer network, computer cluster, or a cloud network.

In some embodiments, one or more of devices 102a, 102b, through 102n of the set of devices 102 is a type of mobile terminal, fixed terminal, or portable terminal including a desktop computer, smart phone, laptop computer, notebook computer, netbook computer, tablet computer, wearable circuitry, mobile handset, server, gaming console, or combination thereof. In some embodiments, one or more of devices 102a, 102b, through 102n of the set of devices 102 include a display by which a user interface (UI) is displayed.

Other configurations, different types of devices, or other number of sets in the set of devices 102 are within the scope of the present disclosure.

The set of edge devices 114 includes at least edge devices 114a, 114b, through 114o, where o is a positive integer corresponding to a number of edge devices in the set of edge devices 114. In some embodiments, integer o is greater than integer n. In some embodiments, integer o is greater than integer n by at least a factor of 100. In some embodiments, the integer o is greater than integer n by at least a factor of 1000. Other factors are within the scope of the present disclosure.

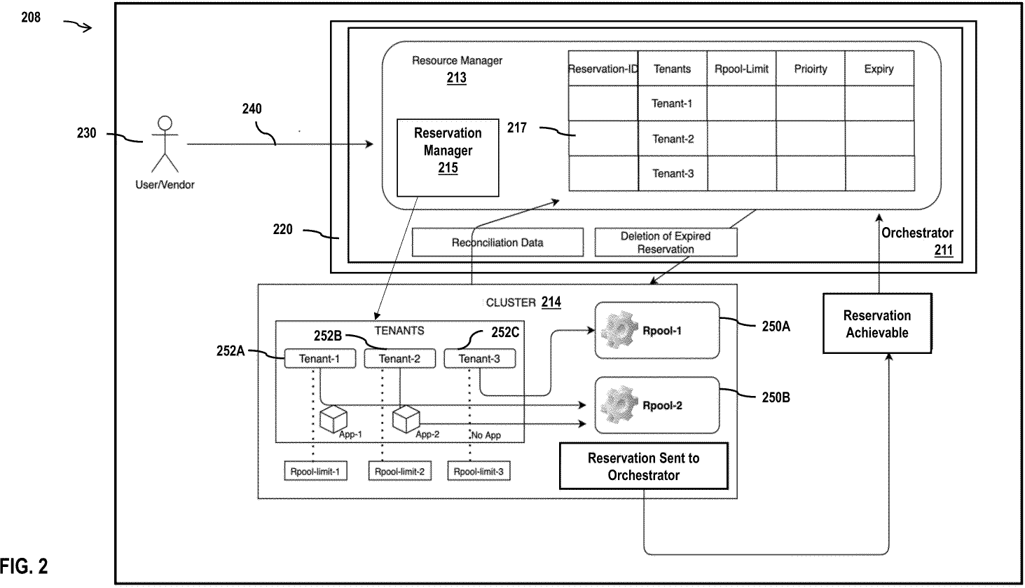

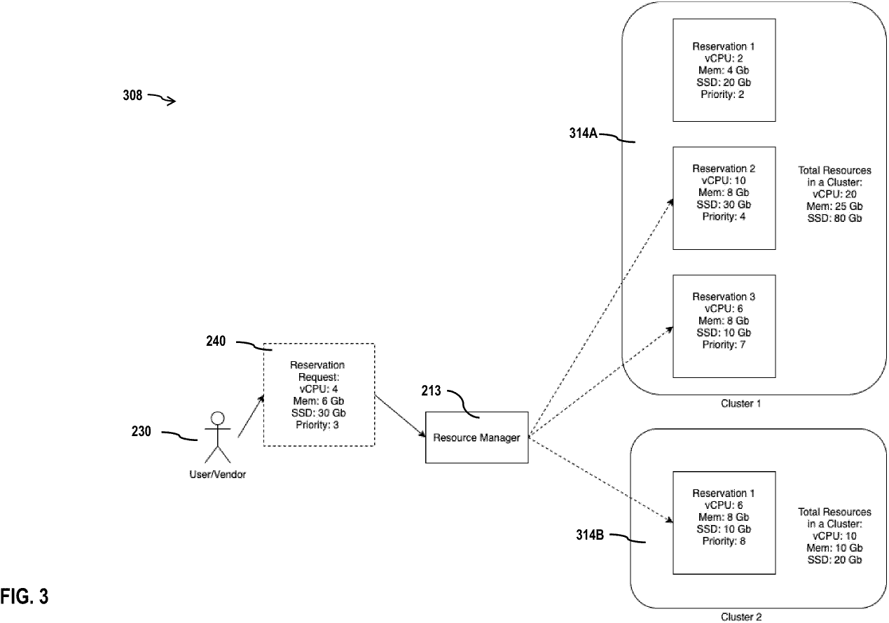

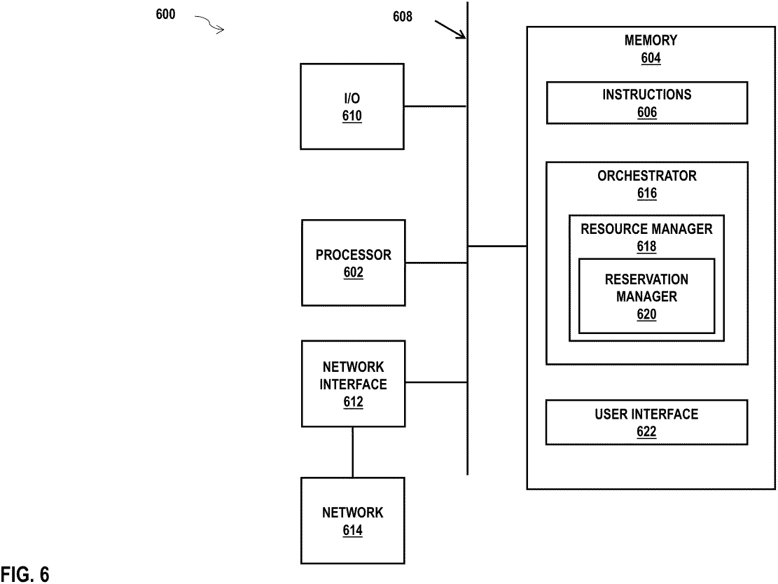

In some embodiments, one or more edge devices in the set of edge devices 114 corresponds to a computing device, computing system, or a server. In some embodiments, the set of edge devices 114 corresponds to one or more server clusters. In some embodiments, each edge device of the set of edge devices 114 corresponds to a server cluster 214 (FIG. 2) or server clusters 314A and 314B (FIG. 3). In some embodiments, system 600 (FIG. 6) is an embodiment of one or more edge devices 114a, 114b, through 114o of the set of edge devices 114.

Other configurations, different types of edge devices or other number of sets in the set of edge devices 114 are within the scope of the present disclosure.

In some embodiments, at least one of network 106 or 112 corresponds to a wired or wireless network. In some embodiments, at least one of network 106 or 112 corresponds to a local area network (LAN). In some embodiments, at least one of network 106 or 112 corresponds to a wide area network (WAN). In some embodiments, at least one of network 106 or 112 corresponds to a metropolitan area network (MAN). In some embodiments, at least one of network 106 or 112 corresponds to an internet area network (IAN), a campus area network (CAN) or a virtual private networks (VPN). In some embodiments, at least one of network 106 or 112 corresponds to the Internet.

In some embodiments, at least one of network 106 or 112 corresponds to a telecommunications network that is a group of nodes interconnected by telecommunications links that are used to exchange messages between the nodes. In some embodiments, the links use a variety of technologies based on the methodologies of circuit switching, message switching, and/or packet switching, to pass messages and signals.

Other configurations, number of networks or different types of networks in at least network 106 or 112 are within the scope of the present disclosure.

In some embodiments, at least one of link 104, 110, or 116 is a wired link. In some embodiments, at least one of link 104, 110, or 116 is a wireless link. In some embodiments, at least one of link 104, 110, or 116 corresponds to any transmission medium type; e.g. fiber optic cabling, any wired cabling, and any wireless link type(s). In some embodiments, at least one of link 104, 110, or 116 corresponds to shielded, twisted-pair cabling, copper cabling, fiber optic cabling, and/or encrypted data links.

In some embodiments, at least one of link 104, 110, or 116 is based on different technologies, such as code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that is used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least one of link 104, 110, or 116 are within the scope of the present disclosure. For example, while FIG. 1 shows a single link for each of links 104, 110, or 116, one or more of links 104, 110, or 116 include a plurality of links.

Other configurations or number of elements in system 100 are within the scope of the present disclosure.

FIG. 2 is a block diagram of a system 208, in accordance with some embodiments. FIG. 2 is simplified for the purpose of illustration.

System 208 is an embodiment of multi-tenant cloud system 208, an example of multi-tenant cloud system 108 and similar detailed description is omitted.

Multi-tenant cloud system 208 includes a device 220 connected to a server cluster 214. In some embodiments, sever cluster 214 is an example of edge devices 114 and similar detailed description is omitted. In some embodiments, server cluster 214 is a Kubernetes-based platform that automates the deployment, scaling and lifecycle management of data and network intensive applications. In some embodiments, server cluster 214 ships pure open-source Kubernetes in a batteries included, but replaceable, packaging mode. In some embodiments, server cluster 214 support the open-source Kubernetes that is shipped with the product and provides automated installation, frequent upgrades, and monitoring. However, one may choose to replace the built-in open-source Kubernetes with cloud-native computing foundation (CNCF)-certified Kubernetes (including on-premises or cloud-vendor distributions) or any other suitable system.

In some embodiments, Kubernetes is an open-source container-orchestration system for automating computer application deployment, scaling, and management maintained by CNCF. In some embodiments, Kubernetes aims to provide a platform for automating deployment, scaling, and operations of database management systems. In some embodiments, Kubernetes works with a range of container tools and runs containers in a cluster, such as cluster 214. Many cloud services offer a Kubernetes-based platform or infrastructure as a service (platform as a service (PaaS) or infrastructure as a service (IaaS)) on which Kubernetes can be deployed as a platform-providing service.

In some embodiments, PaaS or application platform as a service (aPaaS) or platform-based service is a category of cloud computing services that allows customers to provision, instantiate, run, and manage a modular bundle comprising a computing platform and one or more applications, without the complexity of building and maintaining the infrastructure typically associated with developing and launching the application(s); and to allow developers to create, develop, and package such software bundles. In some embodiments, IaaS are online services that provide high-level application programming interfaces (APIs) used to defer various low-level details of underlying network infrastructure like physical computing resources, location, data partitioning, scaling, security, backup etc. A hypervisor, such as Xen, Oracle VirtualBox, Oracle VM, KVM, VMware ESX/ESXi, or Hyper-V runs the virtual machines as guests. Pools of hypervisors within the cloud operational system can support large numbers of virtual machines and the ability to scale services up and down according to customers’ varying requirements.

In some embodiments, cloud native computing is an approach in software development that utilizes cloud computing to build and run scalable applications in modern, dynamic environments such as public, private, and hybrid clouds, such as multi-tenant cloud system 208. Technologies such as containers, microservices, serverless functions and immutable infrastructure, deployed via declarative code are common elements of this architectural style that enable loosely coupled systems that are resilient, manageable, and observable. In some embodiments, cloud-native applications are built as a set of microservices that run in Docker containers, and are orchestrated in Kubernetes. The container runs in a virtualized environment, which isolates the contained application from the environment.

In some embodiments, server cluster 214 is a set of servers that work together so that they are viewed as a single system. In some embodiment, server clusters 214 have an application(s) deployed on each node to perform the same task, controlled and scheduled by software.

FIG. 2 depicts multi-tenant cloud system 208 including a single server cluster 214 for the purpose of illustration. In some embodiments, multi-tenant cloud system 208 includes more than one server cluster 214. In some embodiments, multi-tenant cloud system 308 discussed below with respect to FIG. 3, multi-tenant cloud system 308 includes one or more server clusters 314A and 314B in addition to server cluster 214.

Device 220 is coupled to server cluster 214 by a network (not shown), such as a cloud network or a data center.

Device 220 is configured to receive one or more reservation requests, e.g., a reservation request 240, from one or more users/vendors (represented collectively as user 230). The reservation requests 240 associated to one or more software applications (not shown) and include information indicative of server cluster resource requirements of the corresponding applications.

Device 220 is configured to automatically deploy the one or more software applications on the corresponding server clusters, e.g., server cluster 214. The server clusters are configured to store, execute and provide access to the one or more deployed applications by network 106 and 112 to other devices (including the set of devices 102).

Server cluster 214 is a logical entity of a group of servers, e.g., a group of servers collectively controlled for efficiency and/or to provide backup or other capabilities. Multiple instances of server cluster 214 and/or other server clusters are located in data centers (not shown), each data center including at least one server cluster, e.g., server cluster 214. In some embodiments, system 208 includes tens of data centers. In some embodiments, system 208 includes hundreds or thousands of data centers.

In some embodiments, a given data center includes tens of instances of server clusters, e.g., server cluster 214. In some embodiments, a given data center includes hundreds or thousands of instances of server clusters, e.g., server cluster 214.

In some embodiments, system 208 includes a total number of server clusters, e.g., server cluster 214, ranging from tens of server clusters to hundreds of thousands of server clusters. In some embodiments, system 208 includes the total number of server clusters, e.g., server cluster 214, ranging from hundreds of server clusters to thousands of server clusters. In some embodiments, data centers and the corresponding server clusters, e.g., server cluster 214, are referred to as an ecosystem.

Resource capabilities of the server clusters, also referred to as infrastructure resources in some embodiments, correspond collectively to resource requirements of the one or more software applications and include one or more of a memory requirement/capability, a storage requirement/capability, a central processing unit (CPU) requirement/capability, a supplemental processing requirement/capability, an input-output (I/O) or other hardware interface requirement/capability, a software requirement/capability, a user-specified requirement/capability, or other technical requirement and/or capability suitable for storing and/or executing software applications.

In some embodiments, a memory requirement/capability includes one or more of a memory size, type, configuration, or other criteria suitable for defining computer memory capabilities, e.g., gigabytes (GB) of random-access memory (RAM). A storage requirement/capability includes one or more of a storage type, e.g., hard disk drive (HDD) or solid state drive (SSD), size, configuration, or other criteria suitable for defining data storage capabilities.

In some embodiments, a CPU requirement/capability includes one or more of a number of physical or virtual processor cores, processor speed, or other criteria suitable for defining general computer processing capabilities. A supplemental processing requirement/capability includes one or more application-specific computational requirements/capabilities, e.g., a graphics processing unit (GPU) requirement/capability, a field-programmable gate array (FPGA) requirement/capability, or other requirement/capability provided by hardware supplemental to general processing hardware.

In some embodiments, an I/O or other hardware interface requirement/capability includes one or more of a network interface card (NIC), a single root I/O virtualization (SRIOV), open virtual switch (OVS), or other criteria suitable for defining interfacing capabilities.

In some embodiments, a software requirement/capability includes one or more of an operating system (OS) requirement/capability, e.g., an OS type and/or version, an application programming interface (API) requirement/capability, or other supplemental software requirement/capability.

In some embodiments, a user-specified requirement/capability includes one or more of a geographic location or region, e.g., a country, including one or more server clusters, e.g., server cluster 214, a data center type such as a group center (GC) type corresponding to far edge data centers, a regional data center (RDC) type corresponding to near edge data centers, or a central data center (CDC) type corresponding to centrally located data centers, or other criteria provided by a user suitable for specifying a data center or server cluster technical requirement/capability.

In some embodiments, another technical requirement/capability includes one or more of a tag identifying a server cluster and/or data center type, or other application-specific criteria suitable for identifying server cluster compatibility.

In some embodiments, reservation request 240 corresponds to a telecommunication (Telco) application configured to execute on one or more of the server clusters including server cluster 214 and corresponding to one or more private, application-specific environments, e.g., a virtual radio access network (vRAN). In some embodiments, the resource requirements corresponding to reservation request 240 include one or more FPGA and/or hardware interface requirements corresponding to a Telco application.

A vRAN is part of a mobile telecommunication system. In some embodiments, vRAN implements a radio access technology. In some embodiments, vRAN resides between devices such as a mobile phone, a computer, or any remotely controlled machine, such as devices 102, and provides connection with a core network (CN). In some embodiments, depending on the standard, mobile phones and other wireless connected devices are varyingly known as user equipment (UE), terminal equipment, mobile station (MS), etc. In some embodiments, vRAN functionality is typically provided by a silicon chip residing in both the core network as well as the user equipment.

Device 220 includes an orchestrator 211. Orchestrator 211 is one or more sets of instructions, e.g., program code, configured to automatically provision, orchestrate, manage, and deploy the one or more software applications on the server clusters including server cluster 214. Orchestrator 211 is configured to automatically retrieve resource requirements of the application, e.g., from a service catalog (not shown), and includes a resource manager 213 which further includes a reservation manager 215 configured to match the resource requirements to infrastructure resources and track resource allocations, e.g., in a reservation record 217, as discussed below.

In some embodiments, orchestrator 211 of device 220 is the sole orchestrator of a particular ecosystem, e.g., system 208. In some embodiments, orchestrator 211 of device 220 is one of multiple orchestrators 211 of corresponding multiple devices 220 of a particular ecosystem.

Orchestrator 211 includes a user interface, e.g., a user interface 622 discussed below with respect to FIG. 6, capable of displaying information to user 230, and receiving reservation requests including reservation request 240 from user 230. In some embodiments, user 230 represents a single user. In some embodiments, user 230 represents multiple users.

Orchestrator 211 is configured to store and update information related to user 230 and reservation requests including reservation request 240 in reservation record 217. In some embodiments, reservation record 217 is included in one or more storage devices configured to store information related to various additional functions of orchestrator 211, e.g., a service catalog or server cluster database. In some embodiments, reservation record 217 is included in one or more storage devices independent of additional functions of orchestrator 211. In some embodiments, reservation record 217 includes a database. In the embodiment depicted in FIG. 2, reservation record 217 is located in device 220. In some embodiments, reservation record 217 is located partially or entirely external to device 220, e.g., on another device 102 or on an edge device 114.

Reservation record 217 includes data corresponding to users of device 220, e.g., user 230, and other data suitable for scheduling and maintaining various application reservations on the ecosystem including device 220. Each user is associated with a particular vendor, and each vendor includes one or more tenants, e.g., Tenant-1 252A, Tenant-2 252B, and Tenant-3 252C depicted in FIG. 2, each of which includes one or more users, such as user 230. Users and resource reservations are managed at the tenant level, and tenant-level access is referred to as role-based access in some embodiments.

Resource manager 213 of orchestrator 211 includes reservation manager 215 configured to manage existing and requested resource allocations of the server clusters in accordance with method 500 discussed below. To perform the relevant operations of method 500, reservation manager 215 tracks resource requests and reservations at the tenant level as illustrated in FIG. 2.

In the embodiment depicted in FIG. 2, system 208 includes three tenants and a single server cluster 214 for the purpose of illustration. In some embodiments, system 208 includes fewer or greater than three tenants and/or greater than a single server cluster.

In some embodiments, system 208 is a multi-tenant cloud system. In some embodiments, a multi-tenant cloud system is a cloud computing system that allows multiple users, such as user 230, to share computing resources via a cloud network (e.g., public cloud, private cloud, hybrid cloud, and the like). In some embodiments, multi-tenancy of cloud system 208 makes a greater pool of resources available to a larger group of users.

In some embodiments, a multi-tenant cloud system 208 includes a server cluster 214 comprising multiple resource pools 250A, 250B and multiple tenants 252A, 252B, 252C (e.g., computing resources or applications utilized by different users, and the like); and resource manager 213 performing tasks such as: managing resources request from a user, such as user 230, (e.g., a vendor, a service provider, an individual user, and the like), communicating with cluster 214 to determine available resources, and allocate the resources to user 230.

In one example, when user 230 wants to deploy an application, he sends a resource request, such as resource request 240 (e.g., request for 10 CPU cores for running the application) to resource manager 213. In some embodiments, resource manager 213 determines that cluster 214 has 10 available CPU cores. In some embodiments, resource manager 213 will allocate the 10 available CPU cores to user 230. Accordingly, user 230 uploads the application to cloud system 208 (as one tenant of the multi-tenants 252A, 252B, and 252C in cloud system 208) and executes the application on cloud system 208.

In some embodiments, some users, such as user 230, lack technical knowledge on cloud system 208 and the resource requirements of an application and thus are unable to accurately determine an appropriate amount of resources in a resource request. In some embodiments, the amount of resources requested is excessively more than the amount of resources required for optimally running the application, which in turn results in a waste of resources since the additional resources are allocated to the user but are not utilized. On the other hand, if the amount of resources requested by the user is lower than the amount of resources required for optimally running the application, cloud system 208 determines there is not enough resources to run the application in optimal state, or cloud system 208 simply has less than enough resources to start running the application. In some embodiments, cloud system 208 optimizes resources even when a user requests too many resources or too little resources resulting in resource waste or inadequate resources.

In the embodiment depicted in FIG. 2, a given user, e.g., user 230, has (role-based) access associated with a corresponding one of tenants Tenant-1 252A, Tenant-2 252B, or Tenant-3 252C. Each one of tenants Tenant-1 252A, Tenant-2 252B, and Tenant-3 252C has a corresponding cumulative resource limit Rpool-limit-1 or Rpool-limit-2 (Rpool-Limit in reservation record 217). Cumulative resource limits Rpool-limit-1 and Rpool-limit-2 define upper limits of the combined resources allocated to the users associated with the corresponding tenants Tenant-1 252A, Tenant-2 252B, and Tenant-3 252C. In various embodiments, the allocated resources include one or both of reserved resources assigned to existing resource reservations or resources on which applications have been deployed. In some embodiments, reservation manager 215 is dependent on the limits, such as Rpool-limit-1 and Rpool-limit-2, the Rpool resources to each tenant, such as Tenant-1 252A, Tenant-2 252B, and Tenant-3 252C. In some embodiments, a threshold, such as the Rpool-limits, for each tenant and each tenant’s resources is set so the tenant does not exceed a specific value. In some embodiments, the Rpool limits are configured to ensure that applications are deployed with an acceptable amount of resources and does not exceed the acceptable amount of resources.

Resource manager 213 is configured to receive reservation request 240 including a role-based indicator, e.g., a Reservation-ID, usable for identifying one of tenants Tenant-1 252A, Tenant-2 252B, or Tenant-3 252C. In some embodiments, the role-based indicator corresponds to login or other credentials of user 230. In some embodiments, the role-based indicator corresponds to reservation request 240 or the software application associated with reservation request 240.

Reservation manager 215 is configured to determine cumulative resource requirements corresponding to each of tenants Tenant-1 252A, Tenant-2 252B, and Tenant-3 252C, e.g., in response to receiving reservation request 240, and compare the cumulative resource requirements to the corresponding cumulative resource limit Rpool-limit-1 or Rpool-limit-2.

In the non-limiting example depicted in FIG. 2, resource capabilities of server cluster 206 are grouped into resource pools Rpool-1 and Rpool-2. Each of an existing reservation for application App-1 corresponding to tenant Tenant-1 and an existing reservation for application App-2 corresponding to tenant Tenant-2 is assigned to resource pool Rpool-2, and resource pool Rpool-1 is available for reservation requests corresponding to tenant Tenant-3.

Reservation manager 215 is configured to update reservation record 217 to reflect changes in hardware and software capacities of the server clusters including server cluster 214 corresponding to reservation assignments and software application deployment.

FIG. 3 is a block diagram of a system 300, in accordance with some embodiments.

FIG. 3 depicts a non-limiting example of system 300 including resource manager 213 (other details of device 220 are omitted for the purpose of illustration) and sever clusters 314A and 314B.

Reservation request 240 received from user 230 includes the indicated resource requirements and a vCPU indicator of 4. Existing Reservation 1 of server cluster 314A has a vCPU indicator of 2, existing Reservation 2 of server cluster 314A has vCPU indicator of 10, existing Reservation 3 of server cluster 314A has a vCPU level indicator of 6, and existing Reservation 1 of server cluster 314B has a vCPU level indicator of 6.

Based on the resource requirements and vCPU indicator of reservation request 240, server cluster 314B is configured to support reservation request 240. Server cluster 314A has 20 vCPU. In FIG. 3, server cluster 314A’s 20 vCPUs are currently reserved by Reservation 1 that requires 2 vCPU, Reservation 2 that requires vCPU 10 and Reservation 3 that requires vCPU 6 adding to 18 total vCPU and 2 vCPU that remain in server cluster 314A. However, server cluster 314B has 10 vCPU and Reservation 1 requires 6 vCPU. Thus, there is enough room for server cluster 314B to accept the reservation request 240 as the request is for 4 vCPU which is how much vCPU is left at server cluster 314B.

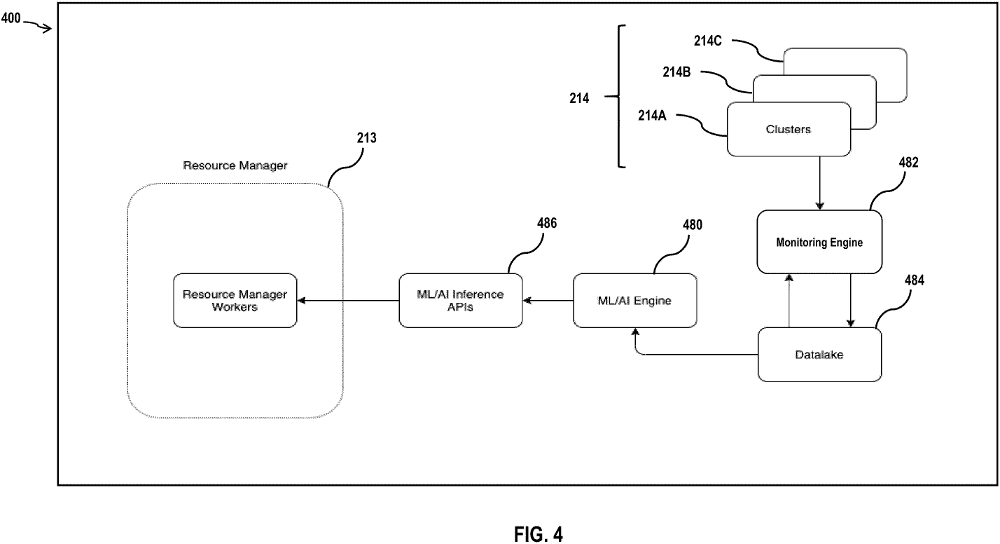

FIG. 4 is a block diagram of a system 400, in accordance with some embodiments.

In some embodiments, a multi-tenant cloud system 400 is an embodiment of multi-tenant cloud system 208 and an example of multi-tenant cloud system 108 and similar detailed description is omitted.

In some embodiments, in response to an application being deployed as a tenant on one or more of set of clusters 214 of multi-tenant cloud system 400, and the deployed application being executed with reserved resources, the resources required for processing the application are monitored by resource manager 213 via a monitoring engine 482. In some embodiments, monitoring engine 482 records real-time metrics in a time series database (allowing for high dimensionality) built using a hypertext transfer protocol (HTTP) pull model, with flexible queries and real-time alerting. In some embodiment, the monitoring engine 482 is a monitoring engine like Prometheus.

Prometheus is an open-source software application used for event monitoring and alerting. Prometheus is a graduated project of the CNCF, along with Kubernetes and Envoy.

In some embodiments, multi-tenant cloud system 400 automatically determines tenant resource limits or Rpool-limits for a tenant, such as tenants 252A, 252B, 252C, or the like. In some embodiments, the tenant resource limit is based on resource usage of the tenant executing an application or another tenant’s past operation with the same application or a similar application. In some embodiments, a predicted tenant resource limit is determined using ML/AI engine 480. In some embodiments, once the ML/AI engine 480 determines a tenant resource limit a recommendation of the intra-tenant resource limits is sent to a network administrator (not shown).

In some embodiments, the network administrator considers the predicted resource requirement of the ML/AI engine 480 and the original resource requirement (e.g., whether or not the requested resource is overly high or insufficient for the tenant). In some embodiments, the network administrator performs an action based on the recommendation (e.g., reclaiming overly-reserved resources to avoid resource wastage or assigning more intra-tenant resources to optimize the performance of the application, and the like).

In some embodiments, in response to a resource reservation, resource manager 213 of system 400 reserves intra-tenant resources (e.g., CPU cores, GPU cores, Memory, SSD Storage and HDD Storage) as well as an upper limit for the users based on intra limits (collectively refer to as intra-tenant limits herein below).

In some embodiments, computing resource usage (e.g., aggregation of CPU usage, Memory usage, and the like) monitored by monitoring engine 482 is stored periodically in a data lake 484 (e.g., a database, a server, and the like) communicatively coupled to resource manager 213. In some embodiments, data lake 484 is a system or repository of data stored in natural/raw format, usually object blobs or files. In some embodiments, data lake 484 is usually a single store of data including raw copies of source system data, sensor data, social data and the like, and transformed data used for tasks such as reporting, visualization, advanced analytics and machine learning. In some embodiments, data lake 484 includes structured data from relational databases (rows and columns), semi-structured data (CSV, logs, XML, JSON), unstructured data (emails, documents, PDFs) and binary data (images, audio, and video). In some embodiments, data lake 484 is established on premises (e.g., within an organization’s data centers) or in the cloud (e.g., using cloud services from one or more vendors).

In some embodiments, periodically a vendor/user deploying an application within a tenant will provide an original reservation request, such as reservation request 240 that greatly deviates from the actual consumption of the resources of the application. In such a scenario, where the requested resources are greater than the application limits (i.e., more resources are reserved for the particular tenant than needed), a resource wastage occurs as the resources are being kept from other reservations or applications (e.g., the excess resources are just sitting idle). In another scenario where the requested resources are insufficient for the application, the application execution quickly approaches or exceeds the intra-tenant thresholds. In such a scenario, an alert is generated for the intra-tenant limits to be increased or predictive horizontal/vertical scaling of resources.

In some embodiments, the intra-tenant limit optimization is externally or manually triggered, or is performed periodically and thus generates alerts to reduce or increase the limits in accordance to the updated status or usage of the tenant.

In some embodiments, application metrics (i.e., info of application and the respective processing resource usage) are analyzed to detect usage patterns for a tenant and to provide an accurate recommendation of an intra-tenant limit.

In some embodiments, the historical processing resource usage of an application is in time-series form and is fed from data lake 484 into ML/AI engine 480 to predict (e.g., using time series forecasting) resource usage of the application in the near future. Time series analysis is a method for analyzing time series data in order to extract meaningful statistics and other characteristics of the data. Time series forecasting is the use of a model to predict future values based on previously observed values. While regression analysis is often employed in such a way as to test relationships between one or more different time series, this type of analysis is not usually called time series analysis, which refers in particular to relationships between different points in time within a single series. Interrupted time series analysis is used to detect changes in the evolution of a time series from before to after some intervention which may affect the underlying variable.

In some embodiments, ARIMA (Auto Regressive Integrated Moving Average) is used. In statistics and econometrics, and in particular in time series analysis, an ARIMA model is a generalization of an autoregressive moving average (ARMA) model. Both of these models are fitted to time series data either to better understand the data or to predict future points in the series (forecasting). ARIMA models are applied in some cases where data show evidence of non-stationarity in the sense of mean (but not variance/auto covariance), where an initial differencing step (corresponding to the integrated part of the model) is applied one or more times to eliminate the non-stationarity of the mean function (i.e., the trend).

In some embodiments, LSTM (Long Short-Term Memory) is used. Long short-term memory (LSTM) is an artificial recurrent neural network (RNN) architecture used in the field of deep learning. Unlike standard feedforward neural networks, LSTM has feedback connections. LSTM processes not only single data points (such as images), but also entire sequences of data (such as speech or video). For example, LSTM is applicable to tasks such as unsegmented, connected handwriting recognition, speech recognition and anomaly detection in network traffic or IDSs (intrusion detection systems).

In some embodiments, STL (Seasonality and Trend decomposition using Loess) method is used. Sometimes the trend and cyclical components are grouped into one, called the trend-cycle component. The trend-cycle component referred to as the trend component, even though containing cyclical behavior. For example, a seasonal decomposition of time series by Loess (STL) plot decomposes a time series into seasonal, trend and irregular components using loess and plots the components separately, whereby the cyclical component (if present in the data) is included in the trend component plot.

In some embodiments, non-ML methods like ARIMA, STL, and the like, are used to make predictions quickly and on a smaller dataset, especially in the initial stage of the deployment of a new application. Once a pre-determined time period (e.g., six months) has passed, modelling is done using deep learning based models like LSTM.

These methods are used to make multi step look ahead predictions either recursively or through multi input multi output models, and capture the trends in the resource usage (e.g., periodic bursts or falls in the usage, and the like). In some embodiments, the default size for prediction is 15 days. So, the predictions are made for the next 15 days (e.g., on an hourly basis) based on the historical data (e.g., historical resource usage, and the like). In some embodiments, this prediction window is adjusted by the user/vendor/network admin.

In some embodiments, moving average filters are used on the prediction to smoothen the noise in the prediction. A moving average is commonly used with time series data to smooth out short-term fluctuations and highlight longer-term trends or cycles. The threshold between short-term and long-term depends on the application, and the parameters of the moving average are set accordingly. Mathematically, a moving average is a type of convolution and viewed as an example of a low-pass filter used in signal processing. When used with non-time series data, a moving average filters higher frequency components without any specific connection to time, although typically some kind of ordering is implied. Viewed simplistically as smoothing the data.

In some embodiments, once the prediction has been smoothed, a new intra-tenant limit is calculated by calculating the maximum value of the smoothened prediction, and the calculated intra-tenant limit is recommended to the user/vendor/network admin.

In some embodiments, in response to a constant trend (with or without periodic bursts in the usage), the intra-tenant limit is calculated as maximum of the predicted values along with a buffer. In some embodiments, a buffer gives the application a leeway to accommodate future spikes in terms of usage. In response to this new intra-tenant limit being smaller than the original intra-tenant limit requested by the user, the new intra-tenant limit is recommended. In some embodiments, a reduction in the intra-tenant limit releases the unused resources back to the resource pool and the released resources are then utilized by other applications or by other tenants.

In response to an increasing trend and/or peak usage surpassing a predefined threshold (e.g., the predefined alert threshold is typically 80% of the intra-tenant limits) within a prediction window, this indicates that the current intra-tenant limit is most likely not sufficient for the tenant (e.g., in running an application) and an alert is raised with the network administrator. In some embodiments, the user/vendor/network administrator, based on this alert, increases the intra-tenant limits or chooses to horizontally/vertically scale particular Rpools. In some embodiments, in response another alert is generated. That is, with an increasing trend where the peak usage is below the threshold within the prediction window, this indicates that the original intra-tenant limit is not sufficient for the tenant and is most likely to be surpassed in the near future. In some embodiments, the user/vendor/network administrator takes action by increasing the intra-tenant limits or chooses to horizontally/vertically scale particular Rpools. In some embodiments, when a new application is first deployed as a tenant of multi-tenant cloud system 400, resource manager 213 initially reserves the amount of intra resources as requested by the user. In some embodiments, the original intra-tenant limit is set slightly higher (e.g., 20% higher) than the amount of the original intra resources requested by the user.

In some embodiments, the actual resource usage of the tenant will be continuously monitored by monitoring engine 482 and the usage data is periodically stored in data lake 484. Subsequently, ML/AI engine 480 periodically extracts the usage data from data lake 484 and then processes the usage data to predict future resource usage of the tenant. In some embodiments, a network admin, via a ML/AI interface APIs 486, configure how the usage prediction should be performed (e.g., prediction windows, algorithm to-be used, and the like).

In response to a prediction that the original intra-tenant limit is higher than the tenant usage in the future, resource manager 213 determines a new intra-tenant limit (e.g., maximum of the predicted usage along with a buffer (e.g., a constant number of redundant resource)) and then recommends the new intra-tenant limit to the network admin. In some embodiments, in response to the original intra-tenant limit being insufficient for the tenant, resource manager 213 alerts the user/vendor/network administrator informing them to take appropriate action (e.g., request the user/vendor to order more resources, request the network admin to pay attention on the tenant in case of sudden failure, and the like).

In some embodiments, the network admin chooses to (1) simply accept the recommended new intra-tenant limit and resource manager 213 reconfigures the recommended intra-tenant limit as the new intra-tenant limit of the tenant; (2) configure the recommended intra-tenant limit (e.g., reduce/increase the buffer, and the like), or (3) reject the recommended intra-tenant limit (e.g., maintain overly-reserved resources for a VIP tenant or critical application, and the like). In some embodiments, resource manager 213 provides to the user/vendor recommendations of possible options of resources (e.g., each of the options will be charged differently), and let the user choose the amount of resources from the options based on needs or budget. Subsequently, the choice of the network admin/user/vendor will be fed back to ML/AI engine 480 and the ML/AI engine 480 will take into consideration the choice in future prediction, so as to increase the accuracy of recommendation for the specific tenant in the future.

In some embodiments, after resetting the original intra-tenant limit with a new intra-tenant limit, monitoring engine 482 continues monitoring the actual performance of the tenant and store the actual usage data in the storage. Thus, during the subsequent prediction process, ML/AI engine 480 determines the accuracy of the previously predicted intra-tenant limit (e.g., by determining whether or not the actual performance of the tenant fulfills the previous prediction, and the like) and refine the ML/AI model accordingly. In some embodiments, system 400 automatically trains the model.

In some embodiment, resource manager 213 determines the characteristics of the tenant (e.g., based on title of application, keyword for describing the application, function of application, and the like) and instructs ML/AI engine 480 to extract from data lake 484 the usage data of other tenants which utilize the application or a similar application. Accordingly, the usage data of other tenants is used in predicting the future resource usage for the tenant.

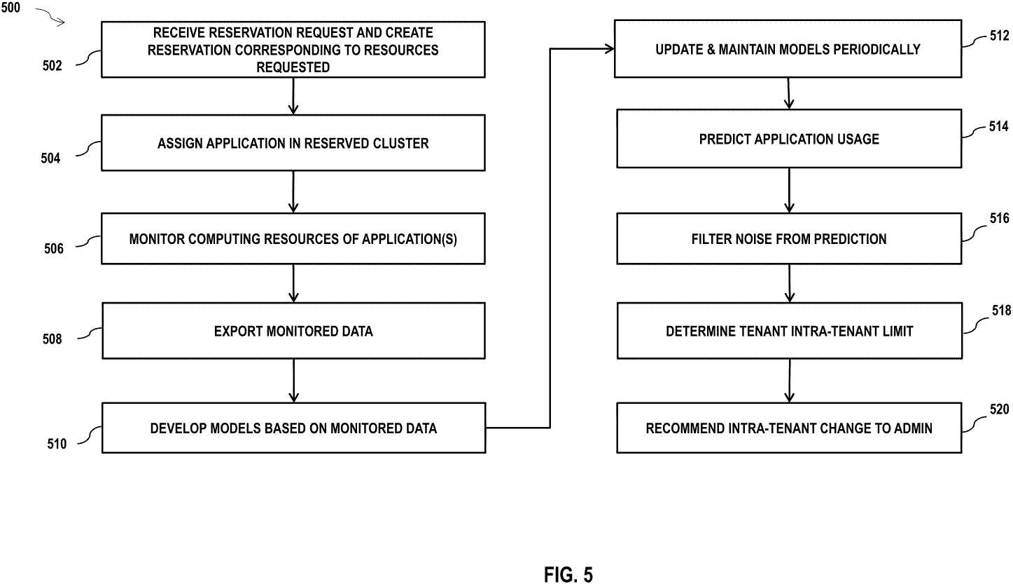

In some embodiments, FIG. 5 is a flowchart of a method of operating system 100 of FIG. 1, system 200 of FIG. 2, system 300 of FIG. 3, or system 400 or FIG. 4, and similar detailed description is therefore omitted. It is understood that additional operations may be performed before, during, between, and/or after the operations of method 500 depicted in FIG. 5, and that some other operations may only be briefly described herein. In some embodiments, other orders of operations of method 500 are within the scope of the present disclosure. In some embodiments, one or more operations of method 500 are not performed.

Method 500 includes operations, but the operations are not necessarily performed in the order shown. Operations may be added, replaced, changed order, and/or eliminated as appropriate, in accordance with the spirit and scope of disclosed embodiments

In some embodiments, a computer-readable medium, such as memory 604 (FIG. 6) including instructions 606 (FIG. 6) executable by a controller, such as processor 602 (FIG. 6) of a user equipment to cause the controller to perform operations.

In some embodiments, method of operating system 500 includes operations 502-520. In operation 502, a reservation request 240 corresponding to resource requirements of an application is received. In a non-limiting example, user 230 initiates a reservation request 240 for resource requirements for a desired application to be stored and executed on a tenant, such as tenant 252A, 252B or 252C. Operation proceeds from operation 502 to operation 504.

In operation 504, the user’s application is assigned to a cluster based upon the user’s reservation request. For example, based on the specified reservation request 240, reservation manager 213 determines a server cluster with the resources capable of handling the application based on the reservation request 240. From operation 504, operation proceeds to operation 506.

In operation 506, a monitoring engine 482 monitors computing resources of the application. For example, monitoring engine 482 monitors computing resource usage (e.g., aggregation of CPU usage, Memory usage, and the like) and stores data periodically in a data lake 484. From operation 506, operation proceeds to operation 508.

In operation 508, data stored in data lake 484 is exported to a ML/AI engine to develop prediction models. For example, the historical processing resource usage of an application is in time-series form and is fed from data lake 484 into ML/AI engine 480 to predict (e.g., using time series forecasting) resource usage of the application in the near future. Form operation 508, operation proceeds to operation 510.

In operation 510, models are developed based on the monitored data by monitoring engine 482. For example, time series forecasting is used as a model to predict future values based on previously observed values. From operation 510, operation proceeds to operation 512.

In operation 512, the models are updated and maintained periodically. For example, ML/AI engine 480 periodically extracts the usage data from data lake 484 and then processes the usage data to predict future resource usage of the tenant. From operation 512, operation proceeds to operation 514.

In operation 514, application usage is predicted. For example, a predicted tenant resource limit is determined using ML/AI engine 480. In some embodiments, once the ML/AI engine 480 determines a tenant resource limit a recommendation of the intra-tenant resource limits is sent to a network administrator (not shown). From operation 514, operation proceeds to operation 516.

In operation 516, noise is filtered from the prediction. For example, moving average filters are used on the prediction to smoothen the noise in the prediction. From operation 516, operation proceeds to operation 518.

In operation 518, a new intra-tenant resource limit is determined. For example, once the prediction has been smoothed, a new intra-tenant limit is calculated by calculating the maximum value of the smoothened prediction, and the calculated intra-tenant limit is recommended to the user/vendor/network admin. Operation proceeds from operation 518 to operation 520.

In operation 520, a recommendation for a new intra-tenant limit is made. For example, once the ML/AI engine 480 determines a tenant resource limit a recommendation of the intra-tenant resource limits is sent to a network administrator.

FIG. 6 is a schematic view of a system 600, in accordance with some embodiments.

In some embodiments, system 600 is an embodiment of device 220 of FIG. 2, and similar detailed description is therefore omitted.

In some embodiments, system 600 is an embodiment of one or more elements in device 220, and similar detailed description is therefore omitted. For example, in some embodiments, system 600 is an embodiment of one or more of orchestrator 211 or resource manager 213, and similar detailed description is therefore omitted.

In some embodiments, system 600 is an embodiment of one or more devices 102 in FIG. 1, and similar detailed description is therefore omitted.

In some embodiments, system 600 is an embodiment of one or more edge devices 106 in FIG. 1 or one or more servers of server clusters 214, 314A, and 314B and similar detailed description is therefore omitted.

In some embodiments, system 600 is configured to perform one or more operations of method 00.

System 600 includes a hardware processor 602 and a non-transitory, computer readable storage medium 604 (e.g., memory 604) encoded with, i.e., storing, the computer program code 606, i.e., a set of executable instructions 606. Computer readable storage medium 604 is configured to interface with at least one of devices 102 in FIG. 1, edge devices 106 in FIG. 1, device 220, or one or more servers of server clusters 214, 314A, and 314B.

Processor 602 is electrically coupled to computer readable storage medium 604 by a bus 608. Processor 602 is also electrically coupled to an I/O interface 610 by bus 608. A network interface 612 is also electrically connected to processor 602 by bus 608. Network interface 612 is connected to a network 614, so that processor 602 and computer readable storage medium 604 are capable of connecting to external elements by network 614. Processor 602 is configured to execute computer program code 606 encoded in computer readable storage medium 604 in order to cause system 600 to be usable for performing a portion or all of the operations as described in method 500. In some embodiments, network 614 is not part of system 600. In some embodiments, network 614 is an embodiment of network 106 or 112 of FIG. 1.

In some embodiments, processor 602 is a central processing unit (CPU), a multi-processor, a distributed processing read circuit, an application specific integrated circuit (ASIC), and/or a suitable processing unit.

In some embodiments, computer readable storage medium 604 is an electronic, magnetic, optical, electromagnetic, infrared, and/or a semiconductor read circuit (or apparatus or device). For example, computer readable storage medium 604 includes a semiconductor or solid-state memory, a magnetic tape, a removable computer diskette, a random access memory (RAM), a read-only memory (ROM), a rigid magnetic disk, and/or an optical disk. In some embodiments using optical disks, computer readable storage medium 604 includes a compact disk-read only memory (CD-ROM), a compact disk-read/write (CD-R/W), and/or a digital video disc (DVD).

In some embodiments, forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term computer-readable storage medium is used herein to refer to a computer-readable medium.

In some embodiments, storage medium 604 stores computer program code 606 configured to cause system 600 to perform one or more operations of method 500. In some embodiments, storage medium 604 also stores information used for performing method 500 as well as information generated during performing method 500, such as orchestrator 616, resource manager 618, user interface 622, and/or a set of executable instructions 606 to perform one or more operations of method 500.

In some embodiments, storage medium 604 stores instructions (e.g., computer program code 606) for interfacing with at least devices 102 in FIG. 1, edge devices 114 in FIG. 1, device 220, orchestrator 211, resource manager 213, or one or more of server clusters 214, 314A, 314B. The instructions (e.g., computer program code 606) enable processor 602 to generate instructions readable by at least devices 102 in FIG. 1, edge devices 114 in FIG. 1, device 220, orchestrator 211, resource manager 213, or one or more of server clusters 214, 314A, 314B to effectively implement one or more operations of method 500 during operation of device 220.

System 600 includes I/O interface 610. I/O interface 610 is coupled to external circuitry. In some embodiments, I/O interface 610 includes a keyboard, keypad, mouse, trackball, trackpad, and/or cursor direction keys for communicating information and commands to processor 602.

System 600 also includes network interface 612 coupled to the processor 602. Network interface 612 allows system 600 to communicate with network 614, to which one or more other computer read circuits are connected. Network interface 612 includes wireless network interfaces such as BLUETOOTH, WIFI, WIMAX, GPRS, or WCDMA; or wired network interface such as ETHERNET, USB, or IEEE-884. In some embodiments, method 500 is implemented in two or more systems 600, and information such as orchestrator 616, resource manager 618, and user interface 622 are exchanged between different systems 600 by network 614.

System 600 is configured to receive information related to orchestrator 616 through I/O interface 610 or network interface 612. The information is transferred to processor 602 by bus 608, and is then stored in computer readable medium 604 as orchestrator 616. In some embodiments, orchestrator 616 including resource manager 618 corresponds to orchestrator 211 including resource manager 213, and similar detailed description is therefore omitted. System 600 is configured to receive information related to orchestrator 616 through I/O interface 610 or network interface 612. System 600 is configured to receive information related to a user interface through I/O interface 610 or network interface 612. The information is stored in computer readable medium 604 as user interface 622.

In some embodiments, method 500 is implemented as a standalone software application for execution by a processor. In some embodiments, method 500 is implemented as corresponding software applications for execution by one or more processors. In some embodiments, method 500 is implemented as a software application that is a part of an additional software application. In some embodiments, method 500 is implemented as a plug-in to a software application.

In some embodiments, method 500 is implemented as a software application that is a portion of an orchestrator tool. In some embodiments, method 500 is implemented as a software application that is used by an orchestrator tool. In some embodiments, one or more of the operations of method 500 is not performed.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. The protection granted hereon be limited only by the definition contained in the appended claims and equivalents thereof.

A system of one or more computers are configured to perform particular operations or actions by virtue of having software, firmware, hardware, or a combination of them installed on the system that in operation causes or cause the system to perform the actions. One or more computer programs are configured to perform particular operations or actions by virtue of including instructions that, when executed by data processing apparatus, cause the apparatus to perform the actions. In some embodiments, a method executed by a processor includes receiving a reservation request corresponding to resource requirements of an application. The reservation request including an amount of resources requested for the application. The method further includes determining an initial intra-tenant threshold based on the reservation request. The method further includes reserving an amount of intra-tenant resources. The amount of intra-tenant resources reserved being greater than the amount of resources requested. The method further includes monitoring tenant resource usage assigned to execute the application. The method further includes storing resource usage data periodically. The method further includes predicting future tenant resource usage based on the resource usage data. The method further includes responsive to the predicted future tenant resource usage, performing at least one of: determining a new intra-tenant threshold to be recommended in response to the initial intra-tenant threshold being set too high or too low, or generating an alert indicating that the initial intra-tenant threshold is insufficient to support the predicted future tenant resource usage. Other embodiments of this aspect include corresponding computer systems, apparatus, and computer programs recorded on one or more computer storage devices, each configured to perform the actions of the methods.

Implementations include one or more of the following features. The method includes performing at least one of: reconfiguring the new intra-tenant threshold as a current intra-tenant threshold; configuring the new intra-tenant threshold as a buffer to the initial intra-tenant threshold; or rejecting the recommended new intra-tenant threshold. The method includes recommending resource usage options based on a resource budget or user applications. The method includes modifying the predicted future tenant resource usage based upon a modification to the initial intra-tenant threshold. The method includes responsive to reconfiguring the new intra-tenant threshold, monitoring the tenant resource usage assigned to execute the application. The predicted future tenant resource usage is an initial predicted future tenant resource usage. The method includes predicting another future tenant resource usage based on continued monitored tenant resource usage. Determining an accuracy of the initial predicted future tenant resource usage. The method includes determining tenant characteristics. Extracting intra-tenant resource usage data of other tenants with a second application. The method includes predicting the future tenant resource usage based on the intra-tenant resource usage data of other tenants with the second application. The predicted future tenant resource usage is an initial predicted future tenant resource usage. The method includes releasing intra-tenant resources back to an intra-tenant resource pool in response to the initial predicted future tenant resource usage being less than actual intra-tenant resource usage. The method includes setting the initial intra-tenant threshold at 80% of the resources requested for the application. Implementations of the described techniques include hardware, a method or process, or computer software on a computer-accessible medium.

In some embodiments, an apparatus includes a memory having non-transitory instructions stored. The apparatus further includes a processor coupled to the memory and being configured to execute the instructions thereby causing the apparatus to receive a reservation request corresponding to resource requirements of an application. The reservation request including an amount of resources requested for the application. Assign the application in a specified reserved tenant. Monitor resource usage of the specified reserved tenant assigned to execute the application. Export resource usage data periodically to a data lake. Responsive to a predetermined amount of time elapsing, develop predictive models based on resource usage data stored in the data lake. Update and maintain the predictive models periodically. Predict application resource usage with the predictive models corresponding to a selected window of time. Other embodiments of this aspect include corresponding computer systems, apparatus, and computer programs recorded on one or more computer storage devices, each configured to perform the actions of the methods.

Implementations include one or more of the following features. The apparatus where the processor coupled to the memory further causing the apparatus to filter noise from the prediction of the predictive models. The processor coupled to the memory further causing the apparatus to determine a tenant resource pool limit. Determine an initial tenant resource pool threshold and aggregate a buffer with the initial tenant resource pool threshold. The processor coupled to the memory further causing the apparatus to responsive to a received tenant pool usage value above the initial tenant resource pool threshold, alert an administrator and suggest change in the tenant resource pool limit. The processor coupled to the memory further causing the apparatus to responsive to a received tenant pool usage value below the initial tenant resource pool threshold, change the initial tenant resource pool threshold to a new tenant resource pool threshold. The new tenant resource pool threshold being lower than the initial tenant resource pool threshold and release a portion of tenant resources back to a tenant resource pool. Implementations of the described techniques include hardware, a method or process, or computer software on a computer-accessible medium.

In some embodiments, a computer-readable medium including instructions executable by a controller of a user equipment to cause the controller to perform operations. The computer -readable medium further includes instructions receiving a reservation request corresponding to resource requirements of an application. The reservation request including an amount of resources requested for the application. The medium further includes instructions determining an initial intra-tenant threshold based on the reservation request. The medium further includes instructions reserving an amount of intra-tenant resources. The amount of intra-tenant resources reserved being greater than the amount of resources requested. The medium further includes instructions monitoring tenant resource usage assigned to execute the application. The medium further includes instructions storing resource usage data periodically. The medium further includes instructions predicting future tenant resource usage based on the resource usage data. The medium further includes instructions responsive to the predicted future tenant resource usage, performing at least one of: determining a new intra-tenant threshold to be recommended in response to the initial intra-tenant threshold being set too high or too low, or generating an alert indicating that the initial intra-tenant threshold is insufficient to support the predicted future tenant resource usage. Other embodiments of this aspect include corresponding computer systems, apparatus, and computer programs recorded on one or more computer storage devices, each configured to perform the actions of the methods.

Implementations include one or more of the following features. The computer-readable medium where the instructions executable by the controller further cause the controller to perform operations includes: determining tenant characteristics. Extracting intra-tenant resource usage data of other tenants with a second application. The instructions executable by the controller further cause the controller to perform operations that include predicting the future tenant resource usage based on the intra-tenant resource usage data of other tenants with the second application. The instructions executable by the controller further cause the controller to perform operations that include releasing intra-tenant resources back to an intra-tenant resource pool in response to the predicted future tenant resource usage being less than actual intra-tenant resource usage. The instructions executable by the controller further cause the controller to perform operations that include setting the initial intra-tenant threshold at 80% of the request resources for the application. Implementations of the described techniques include hardware, a method or process, or computer software on a computer-accessible medium.

The foregoing outlines features of several embodiments so that those skilled in the art better understand the aspects of the present disclosure. Those skilled in the art should appreciate that they are able to readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. A method executed by a processor, the method comprising:
receiving a reservation request corresponding to resource requirements of an application, the reservation request including an amount of resources requested for the application;
determining an initial intra-tenant threshold based on the reservation request;
reserving an amount of intra-tenant resources, the amount of intra-tenant resources reserved being greater than the amount of resources requested;
monitoring tenant resource usage assigned to execute the application;
storing resource usage data periodically;
predicting future tenant resource usage based on the resource usage data; and
responsive to the predicted future tenant resource usage, performing at least one of:
determining a new intra-tenant threshold to be recommended in response to the initial intra-tenant threshold being set too high or too low; or
generating an alert indicating that the initial intra-tenant threshold is insufficient to support the predicted future tenant resource usage.

2. The method of claim 1, further comprising:
performing at least one of:
reconfiguring the new intra-tenant threshold as a current intra-tenant threshold;
configuring the new intra-tenant threshold as a buffer to the initial intra-tenant threshold; or
rejecting the recommended new intra-tenant threshold.

3. The method of claim 1, further comprising:
recommending resource usage options based on a resource budget or user applications.

4. The method of claim 1, further comprising:
modifying the predicted future tenant resource usage based upon a modification to the initial intra-tenant threshold.

5. The method of claim 1, further comprising:
responsive to reconfiguring the new intra-tenant threshold, monitoring the tenant resource usage assigned to execute the application.

6. The method of claim 5, wherein the predicted future tenant resource usage is an initial predicted future tenant resource usage, the method further comprising:
predicting another future tenant resource usage based on continued monitored tenant resource usage; and
determining an accuracy of the initial predicted future tenant resource usage.

7. The method of claim 1, further comprising:
determining tenant characteristics; and
extracting intra-tenant resource usage data of other tenants with a second application.

8. The method of claim 7, further comprising:
predicting the future tenant resource usage based on the intra-tenant resource usage data of other tenants with the second application.

9. The method of claim 1, wherein the predicted future tenant resource usage is an initial predicted future tenant resource usage, the method further comprising:
releasing intra-tenant resources back to a intra-tenant resource pool in response to the initial predicted future tenant resource usage being less than actual intra-tenant resource usage.

10. The method of claim 1, further comprising:
setting the initial intra-tenant threshold at 80% of the resources requested for the application.

11. An apparatus, comprising:
a memory having non-transitory instructions stored; and
a processor coupled to the memory, and being configured to execute the instructions, thereby causing the apparatus to:
receive a reservation request corresponding to resource requirements of an application, the reservation request including an amount of resources requested for the application;
assign the application in a specified reserved tenant;
monitor resource usage of the specified reserved tenant assigned to execute the application;
export resource usage data periodically to a data lake;
responsive to a predetermined amount of time elapsing, develop predictive models based on resource usage data stored in the data lake;
update and maintain the predictive models periodically; and
predict application resource usage with the predictive models corresponding to a selected window of time.

12. The apparatus of claim 11, wherein the processor coupled to the memory further causing the apparatus to:
filter noise from the prediction of the predictive models.

13. The apparatus of claim 11, wherein the processor coupled to the memory further causing the apparatus to:
determine a tenant resource pool limit;
determine an initial tenant resource pool threshold; and
aggregate a buffer with the initial tenant resource pool threshold.

14. The apparatus of claim 13, wherein the processor coupled to the memory further causing the apparatus to:
responsive to a received tenant pool usage value above the initial tenant resource pool threshold, alert an administrator and suggest change in the tenant resource pool limit.

15. The apparatus of claim 13, wherein the processor coupled to the memory further causing the apparatus to:
responsive to a received tenant pool usage value below the initial tenant resource pool threshold, change the initial tenant resource pool threshold to a new tenant resource pool threshold, the new tenant resource pool threshold being lower than the initial tenant resource pool threshold; and
release a portion of tenant resources back to a tenant resource pool.

16. A computer-readable medium including instructions executable by a controller of a user equipment to cause the controller to perform operations comprising:
receiving a reservation request corresponding to resource requirements of an application, the reservation request including an amount of resources requested for the application;
determining an initial intra-tenant threshold based on the reservation request;
reserving an amount of intra-tenant resources, the amount of intra-tenant resources reserved being greater than the amount of resources requested;
monitoring tenant resource usage assigned to execute the application;
storing resource usage data periodically;
predicting future tenant resource usage based on the resource usage data; and
responsive to the predicted future tenant resource usage, performing at least one of:
determining a new intra-tenant threshold to be recommended in response to the initial intra-tenant threshold being set too high or too low; or
generating an alert indicating that the initial intra-tenant threshold is insufficient to support the predicted future tenant resource usage.

17. The computer-readable medium of claim 16, wherein the instructions executable by the controller further cause the controller to perform operations comprising:
determining tenant characteristics; and
extracting intra-tenant resource usage data of other tenants with a second application.

18. The computer-readable medium of claim 17, wherein the instructions executable by the controller further cause the controller to perform operations comprising:
predicting the future tenant resource usage based on the intra-tenant resource usage data of other tenants with the second application.

19. The computer-readable medium of claim 16, wherein the instructions executable by the controller further cause the controller to perform operations comprising:
releasing intra-tenant resources back to a intra-tenant resource pool in response to the predicted future tenant resource usage being less than actual intra-tenant resource usage.

20. The computer-readable medium of claim 16, wherein the instructions executable by the controller further cause the controller to perform operations comprising:
setting the initial intra-tenant threshold at 80% of the request resources for the application.
